(19) United States
(12) Patent Application Publication
(10) Pub. No.: US 2026/0326728 A1
(43) Pub. Date: Oct. 22, 2026

(54) METHOD FOR OPERATING AN ELECTROPNEUMATIC BRAKE SYSTEM FOR A VEHICLE, IN PARTICULAR A COMMERCIAL VEHICLE, COMPUTER PROGRAM AND/OR COMPUTER-READABLE MEDIUM, CONTROLLER, AND VEHICLE

(71) Applicant: ZF CV Systems Global GmbH, Bern (CH)

(72) Inventors: Alexander Rodenberg, Braunschweig (DE); Steffen Gerlach, Hannover (DE); Axel Stender, Hameln (DE); Christoph Schowe, Gehrden (DE)

(21) Appl. No.: 19/468,996

(22) Filed: Feb. 3, 2026

Related U.S. Application Data
(63) Continuation of application No. PCT/EP2024/074395, filed on Sep. 2, 2024.

(30) Foreign Application Priority Data
Sep. 19, 2023 (DE) 10 2023 125 299.2

(51) Int. Cl. B60T 8/17; B60T 8/171; B60T 8/172; B60T 8/18

(52) U.S. Cl. CPC B60T 8/1708; B60T 8/171; B60T 8/172; B60T 8/1843; B60T 8/1887; B60T 2250/00

(57) ABSTRACT

A method is for operating an electropneumatic braking system for a vehicle, in particular a commercial vehicle. The vehicle includes a pneumatic suspension system having a bellows and a pressure sensor for measuring a bellows pressure of the bellows. The bellows pressure is measured during braking effected by a braking request and achieved with a braking pressure. A braking parameter is determined on the basis of the bellows pressure and/or a bellows-pressure change that is derivable from the bellows pressure and a braking parameter difference between the braking parameter and a target braking parameter that is determinable on the basis of the braking request and/or the braking pressure is determined. A control signal for adapting the braking pressure is output depending on the braking parameter difference.

### CROSS-REFERENCE TO RELATED APPLICATIONS

This application is a continuation application of international patent application PCT/EP2024/074395, filed Sep. 2, 2024, designating the United States and claiming priority from German application 10 2023 125 299.2, filed Sep. 19, 2023, and the entire content of both applications is incorporated herein by reference.

### TECHNICAL FIELD

The disclosure relates to a method for operating an electropneumatic brake system for a vehicle, in particular a commercial vehicle, wherein the vehicle has a pneumatic suspension system having a bellows and has a pressure sensor for capturing a bellows pressure of the bellows. The disclosure relates also to a computer program and/or computer-readable medium, to a control device for a vehicle, in particular a commercial vehicle, and to a vehicle, in particular a commercial vehicle, having a pneumatic suspension system having a bellows, having an electropneumatic brake system having a brake cylinder, a pressure sensor device for capturing a bellows pressure of the bellows and a brake pressure of the brake cylinder, and having a control device connected to the pressure sensor device.

### BACKGROUND

The vehicle, in particular the commercial vehicle, is referred to below as vehicle. A vehicle of this kind has a plurality of wheels. One or more of the wheels makes or make contact with an underlying surface via a respective wheel contact area. In this case, a braking force can denote the force acting counter to the speed of travel in the vehicle longitudinal direction in each wheel contact area during braking or deceleration of the vehicle. It is not possible to ascertain exactly the braking force while operation is in progress, that is, during driving or during braking, since it is not possible to arrange sensors for measuring the braking force in the wheel contact areas.

Monitoring the braking force and/or a braking variable correlated with the braking force may be desirable in order to obtain information on a state or possible defects of a brake producing the braking force and/or of a component of the brake.

In particular, the braking effect of a brake with brake pads that is assigned to a wheel may decrease over time. This can be caused by so-called falling asleep of the brake pads as a result of insufficient temperature introduction. Reasons for this may be: vehicles with wear-free endurance brakes (retarders), which are used instead of brakes with brake pads, electrified vehicles with recuperation devices as wear-free endurance brakes, frequent driving with a low axle load, so that only low brake pressures are outputted by the brake system taking into account the axle load, predominantly driving at constant speed over long distances, for example in long-distance traffic.

WO 2016/030699 A1 discloses a method for monitoring the braking power of a vehicle. For at least some braking events, the method includes: determining a braking requirement; determining the vehicle deceleration; defining a first dataset of braking events, wherein each braking event in the dataset includes an ascertained braking requirement and an ascertained vehicle deceleration; applying a statistical trend analysis method to the dataset in order to generate a vehicle-deceleration and braking-requirement trend; providing a vehicle-deceleration and braking-requirement reference; and comparing at least one trend value with at least one reference value. This comparison can be used to determine whether the brake system is operating within acceptable limits. A device for carrying out the method is also disclosed.

Thus, a method is known in which monitoring of the trailer braking effect is carried out by measuring the vehicle deceleration. In other words, an algorithm is used to calculate, during driving and on the basis of sensors that are present (for example, axle load, wheel speeds and vehicle acceleration), whether and how the deceleration due to the current brake pressure correlates to the vehicle mass. Since such systems are often implemented only in the trailer vehicle and the control device thereof has no information about an endurance brake and/or recuperation device installed in the tractor, defects of individual wheel brakes of the trailer vehicle can remain undetected. In addition, for improved functionality, wheel speed sensors are required on all wheels, and this is typically not the case in trailers in particular. In the case of three-axle vehicles, usually only the middle axle is sensed.

DE 10 2022 127 155.2, which had not yet been published on the date of application, describes a method which, on the basis of the measured braking force, outputs a warning in the event of a deviation from a current setpoint.

Other methods require sensors on each individual wheel brake, which can be complex, error-prone and costly.

### SUMMARY

It is an object of the disclosure to improve aspects of the prior art. In particular, the disclosure achieves the object of allowing a required braking ratio to be restored in the event of a detected deviation.

The object is, for example, achieved by a method according to various embodiments of the disclosure.

According to one aspect of the disclosure, a method for operating an electropneumatic brake system for a vehicle, in particular a commercial vehicle, is provided, wherein the vehicle has a pneumatic suspension system having a bellows and has a pressure sensor for capturing a bellows pressure of the bellows. The bellows pressure is captured during a braking operation initiated by a braking request and achieved with a brake pressure. A braking variable is ascertained on the basis of the bellows pressure and/or a bellows pressure change that can be derived from the bellows pressure, and a braking variable difference between the braking variable and a setpoint braking variable that can be determined on the basis of the braking request and/or the brake pressure is determined. A control signal for adjusting the brake pressure in dependence on the braking variable difference is outputted.

In this case, it has been recognized that the braking variable, which can act on one of the wheels, may have an effect on the pressure within the bellows. Braking of a wheel leads to a braking torque acting on the wheel, and the braking torque leads to a force on the bellows. Here, the bellows is configured to control an arrangement of the wheel relative to, for example, a vehicle frame of the vehicle. In this case, the pressure within the bellows may change, for example on account of pressure control that counteracts the force, compression of the bellows or expansion of the bellows. Thus, braking the vehicle may lead to a change in the bellows pressure. The bellows pressure can be captured by sensors in order to ascertain the bellows pressure change.

It has been recognized that there is a relationship between the bellows pressure change and the force acting on the bellows, and that the force acting on the bellows depends on the braking variable. Therefore, the bellows pressure change may be used to determine the braking variable. In order to determine the braking variable, the bellows pressure change can be multiplied by a constant, in particular a vehicle-specific or vehicle-type-specific constant, and/or additional contributions can be taken into account to increase accuracy.

On-board measurement of the braking variable of a vehicle and, in particular, of a trailer vehicle is thereby possible. Particularly in the case of a trailer vehicle, determining the braking variable is possible in a manner very largely independent of effects due to the tractor. Determining the braking variable avoids the need for additional sensors, such as height sensors, force sensors or strain gages, and it enables reliable and effective determination of the braking variable. It is possible to avoid the need, for example, to perform height measurement and the need to convert a change in height into a change in volume of the bellows via a complicated relationship in order to infer the braking force.

According to the disclosure, the setpoint braking variable can be determined from the braking request and/or the brake pressure. The setpoint braking variable can define a required braking variable, that is, a required braking force and/or braking ratio. The method allows the control signal to adjust the brake pressure in the event of a difference between the braking variable and the setpoint braking variable in order to effect an adjustment of, in particular an increase or decrease in, the braking variable. This allows the braking variable to adapt to the setpoint braking variable via the control signal and thus by the adjustment of the brake pressure. This means that a required braking variable can be restored if, for example, a brake force as the braking variable deviates from its specification.

Optionally, the control signal is outputted such that the brake pressure is increased or decreased in dependence on the braking variable difference. In other words, the outputting of a control signal for increasing the brake pressure is effected in dependence on the braking variable difference. It can thus be achieved that a required braking variable can be restored if, for example, a braking force as the braking variable deviates from its specification, for example, on account of damp brake linings, rust on the brake disks/drums and/or a lack of thermal activation of the friction material. Underbraking of the vehicle can thus be counteracted. Alternatively, the outputting of a control signal for reducing the brake pressure is effected in dependence on the braking variable difference. This can be relevant in particular for particularly powerful brake systems if the braking variable is too strong and needs to be reduced. Overbraking of the vehicle can thus be counteracted.

Optionally, the control signal is outputted such that the brake pressure is increased if the braking variable is smaller than the setpoint braking variable. In this case, it has been recognized that an increase in the brake pressure typically leads to an increase in the braking variable. The braking variable can thus be adapted to the setpoint braking variable. If the braking variable is equal to or greater than the setpoint braking variable, the control signal may be dispensed with.

Optionally, the control signal is outputted such that the brake pressure is adjusted if the braking variable difference exceeds a threshold value. In this case, it has been recognized that a braking variable difference that is only small, that is, a braking variable difference below the threshold value, can be compensated by a configuration of the brake system and its control reserve and/or can be tolerated by a minimum requirement of the braking variable difference. The control signal can thus be dispensed with in the case of a braking variable difference that is only small.

Optionally, the brake pressure is increased such that at least the setpoint braking variable is corrected at the brake pressure. In this case, it has been recognized that there is typically a functional relationship between brake pressure and braking variable. The functional relationship can be used to establish the setpoint braking variable as the braking variable at the given brake pressure.

Optionally, the brake pressure is adjusted such that a standardized standard braking variable and/or a braking variable within a predetermined braking variable range is established at the brake pressure. In this case, it has been recognized that there is typically a standardized, that is, a defined, standard braking variable for a defined brake pressure, optionally with a braking variable range to be considered as a tolerance range. This can be used to establish the standard braking variable as the braking variable and/or a braking variable in the braking variable range at the given brake pressure. If the braking variable differs comparatively greatly from its specification, the increase in the braking force can be extended by not only establishing a specified setpoint braking variable but increasing it such that the braking variable lies at the maximum, upper edge of the braking variable range. This allows the thermal input into the brake, which is required for its conditioning, to be increased further.

Optionally, an axle load can be captured in the method and the braking variable can be a braking ratio determined taking into account the axle load. The braking ratio can be a ratio or a quotient of a braking force and the axle load. The braking variable can thus be an insightful measure of the achievable deceleration due to the function of the brake system.

Optionally, the setpoint braking variable is determined on the basis of a segmented linear relationship between the setpoint braking variable and the brake pressure. In this case, it has been recognized that the braking variable is typically related to the brake pressure in a segmented linear manner. For example, the braking variable can be constant below a threshold value of the brake pressure and increase with the brake pressure above the threshold value. Accordingly, it has been recognized that a segmented linear relationship between the brake pressure and the setpoint braking variable is also required and/or expected. This relationship can be used to draw an effective and unambiguous conclusion on the setpoint braking variable in the event of a braking request with a brake pressure.

According to one aspect of the disclosure, a computer program and/or computer-readable medium are/is provided, including commands which, when the program or the commands is or are executed by a control device, cause the latter to carry out the method described above and/or the steps of the method described above. Optionally, the computer program and/or the computer-readable medium include(s) commands which, when the program or the commands is or are executed by a control device, cause the latter to implement a feature, described as optional and/or advantageous, of the method described above in order to achieve a technical effect associated therewith.

According to one aspect of the disclosure, a control device for a vehicle, in particular a commercial vehicle, is provided. The control device is configured to carry out the method described above. Optionally, the control device is configured to implement a feature, described as optional and/or advantageous, of the method described above in order to achieve a technical effect associated therewith.

For ascertaining the braking variable and/or for determining the braking variable difference, the control device is optionally configured for transmitting the brake pressure, the braking request, the bellows pressure change and/or the bellows pressure to a data processing device, different from the control device, on the vehicle, in particular the commercial vehicle. Here, the data processing device can effect ascertaining of the braking variable. This ensures that only data relating to the bellows pressure or the bellows pressure change have to be processed, in particular captured and transmitted, by the control device, for example, a brake control device or a central control device on a trailer.

According to one aspect of the disclosure there is provided a vehicle, in particular a commercial vehicle, having a pneumatic suspension system having a bellows, having an electropneumatic brake system having a brake cylinder, a pressure sensor device for capturing a bellows pressure of the bellows and a brake pressure of the brake cylinder, and having an above-described control device connected to the pressure sensor device. The pneumatic suspension system may have multiple bellows and the electropneumatic brake system may have multiple brake cylinders and the pressure sensor device can capture a bellows pressure of exactly one, multiple or all of the bellows and a brake pressure of exactly one, multiple or all of the brake cylinders. Optionally, the vehicle is configured to implement a feature, described as optional or advantageous, of the method described above and/or has one of the features described above as optional and/or advantageous in order to achieve a technical effect associated therewith.

Optionally, the vehicle, in particular the commercial vehicle, is a trailer vehicle of a multi-unit vehicle. Thus, determination of the braking variable is performed in the trailer vehicle, in particular of a semitrailer. In principle however, the method described above can also be applied to tractors or vehicles of which the axles have running gear configurations comparable to trailer vehicles and in which the braking torque is supported via the air spring bellows. By applying the method in the trailer vehicle, brake matching can be achieved, that is, a respective braking ratio of the tractor and trailer vehicle with a braking ratio that is as equal as possible. This can reduce and/or prevent thrust and/or pulling forces between the tractor and the trailer vehicle.

### BRIEF DESCRIPTION OF DRAWINGS

The invention will now be described with reference to the drawings wherein:

FIG. 1 shows a schematic illustration of a vehicle, in particular a commercial vehicle, according to one aspect of the disclosure;

FIG. 2 shows a schematic illustration of a detail of a vehicle, in particular a commercial vehicle, according to one aspect of the disclosure;

FIG. 3 shows a schematic illustration of a trailer as a vehicle, in particular a commercial vehicle, according to one aspect of the disclosure;

FIG. 4 shows a schematic illustration of a trailer as a vehicle, in particular a commercial vehicle, according to one aspect of the disclosure;

FIG. 5 shows a schematic illustration of a flow chart of a method according to one aspect of the disclosure;

FIG. 6 shows a segmented linear relationship for carrying out a method according to one aspect of the disclosure; and,

FIG. 7 shows a schematic illustration of a computer-readable medium according to one aspect of the disclosure.

### DETAILED DESCRIPTION

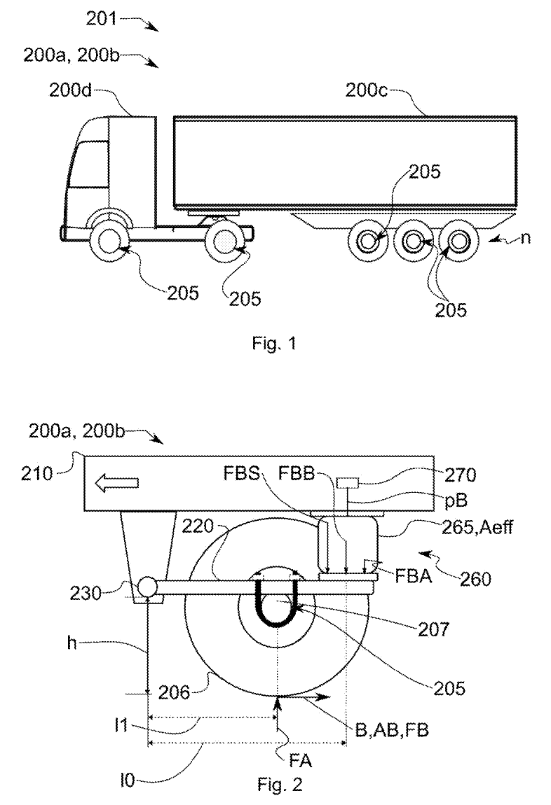

FIG. 1 shows a schematic illustration of a vehicle 200a, in particular a commercial vehicle 200b, according to one aspect of the disclosure.

The vehicle 200a, in particular the commercial vehicle 200b, is referred to below as vehicle 200a, 200b. The vehicle 200a, 200b is a land vehicle. The vehicle 200a, 200bis a multi-unit vehicle 201, also referred to as a vehicle combination, and, in the example shown, has a tractor 200d and a trailer 200c, also referred to as a trailer vehicle, coupled to the tractor 200d. In another embodiment, the vehicle 200a, 200b may also have multiple trailer vehicles 200c (not shown) or be formed by a trailer vehicle 200c.

A vehicle 200a, 200b of this kind has a plurality of n axles 205 indicated schematically. In this case, the trailer vehicle 200c may have one (not shown) or more of the axles 205. On each of the axles 205, the vehicle 200a, 200b has wheels 206 assigned to the respective axle 205 (see FIG. 2). One or more of the wheels 206 makes or make contact with an underlying surface (not shown) via a respective wheel contact area. In this case, a braking force FB (see FIGS. 2-4) can act as a force acting counter to the speed of travel in the vehicle longitudinal direction in each wheel contact area during braking or deceleration of the vehicle 200a, 200b. The braking force FB is a braking variable B. A braking ratio AB is likewise a braking variable B, which characterizes the deceleration of the vehicle 200a, 200b. Here, the braking ratio AB is defined, for example, as the ratio of the braking force FB to an axle load FA.

Details of the vehicle 200a, 200b are described with reference to FIGS. 2-4.

FIG. 2 shows a schematic illustration of a detail of a vehicle 200a, 200b according to one aspect of the disclosure. In this case, FIG. 2 shows an axle configuration. An axle configuration of this kind or an axle configuration that acts in a similar way in principle is typical of a trailer vehicle 200c.

Accordingly, the vehicle 200a, 200b has a vehicle frame 210. The vehicle frame 210 is a sheet-metal and/or tubular structure and has a load bearing function, and running gear components are connected to the vehicle frame 210. In particular, the vehicle 200a, 200b has a pneumatic suspension system 260, which has components connected to the vehicle frame 210.

In particular, the pneumatic suspension system 260 includes a bellows 265 or air spring bellows assigned to a wheel 206 and/or an axle 205. The vehicle 200a, 200b includes a device for supplying compressed air to fill the bellows 265 (see FIG. 4). It is possible to fill the bellows 265 and/or to vent the bellows 265 via valves 297 (see FIG. 4) on the vehicle 200a, 200b.

The vehicle 200a, 200b includes an axle tube 207 forming the axle 205. On each side, the axle tube 207 is firmly connected to a suspension link 220 of the vehicle 200a, 200b. At one end of the suspension link 220, the suspension link 220 is connected rotatably to the vehicle frame 210 by a mounting 230 including a bolt. The bellows 265, with the aid of which the vehicle 200a, 200b can be sprung and damped and the axle 205 can optionally be adjusted in height, is arranged at the other end of the suspension link 220, that remote from the mounting 230. For this purpose, the suspension link 220 is connected to the axle tube 207. A distance l1 between the mounting 230 and the axle 205 or the axle tube 207 defines a length of a lever supported on the mounting 230 and engaging on the axle 205. The distance l1 between the mounting 230 and the axle 205 can be measured and is a vehicle-specific or vehicle-type-specific constant.

The vehicle 200a, 200b includes a pressure sensor 270. The pressure sensor 270 is configured to measure a bellows pressure pB. The pressure sensor 270 can be configured to measure bellows pressures pB of a plurality of bellows 265 (see FIG. 4). Here, the bellows pressure pB is the pressure which prevails in the interior of the bellows 265. The bellows 265 has an area of action Aeff which, together with the bellows pressure pB, defines a force imparted by the bellows 265.

The mounting 230 is arranged at a height h. The height h is defined as the vertical distance between the mounting 230 and the underlying surface and/or the wheel contact area. The height h can be measured and/or can be estimated from a radius of the wheel 206. The height h is essentially a vehicle-specific or vehicle-type-specific constant.

The suspension link 220 has a length l0 of the suspension link 220. The length l0 of the suspension link 220 is defined as the distance between the mounting 230 and the bellows 265 along the suspension link 220. The length l0 of the suspension link 220 thus defines a length of a lever arm supported on the mounting 230 and engaging on the bellows 265. The length l0 of the suspension link 220 can be measured and is a vehicle-specific or vehicle-type-specific constant.

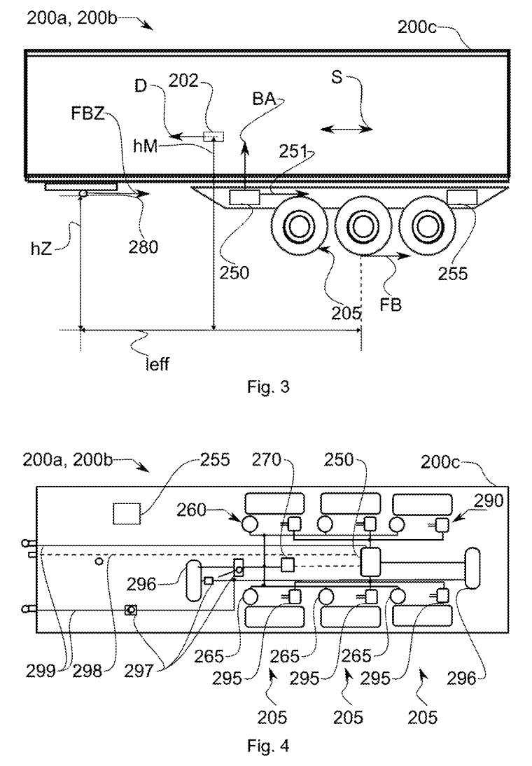

The vehicle 200a, 200b has a brake system 290 (not shown in FIG. 2; see FIG. 4) for braking the wheel 206. The brake system 290 is configured to exert a braking torque on the wheel 206 in order to decelerate the rotary motion of the wheel 206 via a braking force FB acting in the wheel contact area. By virtue of the configuration shown in FIG. 2, a braking torque acting on the wheel 206, and thus the braking force FB, leads to a counterforce on the bellows 265 or a force due to braking FBB on the bellows 265. The braking force FB thus leads to a bellows pressure change pD in the bellows 265. The bellows pressure pB and thus the bellows pressure change pD as well as a brake pressure BP with which the braking system 290 is supplied can be measured via the pressure sensor 270 and can be transmitted to a control device 250 of the vehicle 200a, 200b (see FIGS. 3 and 4).

The forces FBA, FBS, FBB acting on the bellows 265 include the following components: a static force FBS on the bellows 265, that is, a force resulting from a static contribution of the axle load FA; a force FBB resulting from support for the braking torque, and a force FBA due to an axle load transfer S, that is, a dynamic axle load transfer during deceleration or a dynamic contribution of the axle load FA.

The forces FBA, FBS, FBB and the bellows pressure pB are in the following relationship: FBA+FBS+FBB = pB x 2 x Aeff. In other words, the sum of the force FBA on the bellows 265 due to the axle load transfer S plus the static force FBS on the bellows 265 plus the force FBB on the bellows 265 is equal to twice the product of the bellows pressure pB and the area of action Aeff. Here, the factor two results from the number of bellows 265 per axle 205, is a vehicle-specific or vehicle-type-specific constant and, in other embodiments, may be an entirely different number.

One way in which the individual components of the forces FBA, FBS, FBB acting on the bellows 265 can be calculated is explained below.

The effective area of action Aeff of the bellows 265 can be measured or ascertained from data from a load-dependent braking force calculation or can be taken from the datasheets provided by the bellows or axle manufacturer and is a vehicle-specific or vehicle-type-specific constant. The corresponding data from the load-dependent braking force calculation are typically stored in a control device 250, in particular a brake control device of a trailer vehicle. In this case, a relationship between a mass of the vehicle 200a, 200b and the bellows pressure pB is typically stored in the control device 250. The area of action Aeff is then obtained as (mb-mu) x g x l1 / (2 x (pb-pu) x l0), where mb is the mass of the laden vehicle 200a, 200b, mu is the mass of the unladen vehicle 200a, 200b, pb is the bellows pressure pB of the laden vehicle 200a, 200b, pu is the bellows pressure pB of the unladen vehicle 200a, 200b, l0 is the length of the suspension link 220, l1 is the distance between the mounting 230 and the axle 205, and g is the location factor.

The force FBS resulting from the static axle load on the bellows 265 is equal to the product of the static component of the axle load FA,statisch and the distance l1 between the mounting 230 and the axle 205 divided by the length l0 of the suspension link 220: FBS = FA,statisch x l1/l0.

By observing and storing the bellows pressure pB at the start of braking, a suitable reference pressure pRef for the bellows pressure change pD can be formed, and therefore only one evaluation of the bellows pressure change pD is required in the course of braking. The bellows pressure change pD denotes the rise in the bellows pressure pB during braking in comparison with the bellows pressure pB before braking. In this case, the maximum bellows pressure pB during braking can be used to calculate the bellows pressure change pD in order to calculate the bellows pressure change pD using the reference pressure pRef.

The formation of a sum of forces or torques produces the following equation for the relationship between the braking force FB and the supporting force or the force FBB on the bellows 265: FB = FBB x l0 / h, that is, the braking force FB is equal to the force FBB on the bellows 265 multiplied by the length l0 of a suspension link 220 divided by the height h of the mounting 230.

The calculation rule for the braking force FB, neglecting the axle load transfer (see FIG. 3), is then: FB = pD x 2 x Aeff x l0 / h, that is, the braking force FB is equal to twice the product of the area of action Aeff and the length l0 of the suspension link 220 divided by the height h of the mounting 230. Here, the term 2 x Aeff x l0 / h is a vehicle-specific or vehicle-type-specific constant. A vehicle-specific or vehicle-type-specific constant can be stored in the memory of the control device 250, for example.

Specifically in the case of a semitrailer, which typically has a plurality of axles 205 grouped into an axle unit, the bellows 265 of these axles 205 are connected to one another as a whole or at least on each side. Thus, it is possible to ascertain the braking force FB of the vehicle 200a, 200b and/or of the axle unit.

FIG. 3 shows a schematic illustration of a trailer 200c as a vehicle 200a, in particular a commercial vehicle 200b, according to one aspect of the disclosure. Here, an axle 205 or a plurality of axles 205 and the pneumatic suspension system 260 of the trailer 200c can be configured as described with reference to FIG. 2. FIG. 3 is described with reference to FIG. 1 and 2.

To enable the trailer 200c to be coupled to the tractor 200d (see FIG. 1), the trailer 200c according to FIG. 3 has a kingpin 280, via which forces can be transmitted between the trailer 200c and the tractor 200d.

In particular, it is possible, during braking of the tractor 200b, for a pin braking force FBZ, that is, a force acting via the tractor 200d on the kingpin 280 on the trailer 200c, or, in particular, the horizontal component of the force, to be transmitted. The pin braking force FBZ results from the circumstance that the tractor 200d brakes the mass of the trailer 200c resting on a fifth-wheel pick-up plate of the tractor 200d. The kingpin 280 is arranged at a pin height hZ as a vertical distance between the kingpin 280 and the underlying surface and/or the wheel contact area. The pin height hZ is a vehicle-specific or vehicle-type-specific constant.

The trailer 200c has a center of gravity 202. To establish the center of gravity 202, uniform loading of the trailer 200c can be assumed. The driving dynamics of the trailer 200c can be characterized by a vehicle deceleration D during a braking operation.

The center of gravity 202 is arranged at a center of gravity height hM, which can be estimated and/or taken from data from the braking calculation of the vehicle 200a, 200b. Deviations from the assumptions, for example, between the assumed and the actual center of gravity height hM, lead only to insignificant deviations in the following considerations. The center of gravity height hM is essentially a vehicle-specific or vehicle-type-specific constant.

If influences of the axle load transfer S during braking are taken into account, the calculation of the braking variable B or of the braking force FB and/or of the braking ratio AB can be improved. For this purpose, assumptions are made, for example, for the center of gravity height hM and the pin force FBZ transmitted by the kingpin 280. Dynamic axle load shifting S during braking relieves the load on the rear axle unit of the semitrailer and thus generates a force FBA on the bellows 265 by the axle load shifting S. This force FBA on the bellows 265 by the axle load shifting S can, with the inclusion of deceleration D and center of gravity height hM of trailer 200c, be ascertained as follows: FBA = ( - m x D x hM + FBZ x hZ ) x l1 / (n x leff x l0), that is, force FBA on the bellows 265 due to the axle load transfer S is equal to the quotient of the distance l1 between the mounting 230 and the axle 205 and the product of the number n of axles 205, the effective wheelbase leff and the length l0 of the suspension link 220 multiplied by the sum of the product of the mass m of the vehicle 200, 200b, the deceleration D and the center of gravity height hM and the product of the pin braking force FBK and the pin height hZ. Here, the effective wheelbase leff is a measure of the horizontal distance between the kingpin 280 and the axles 205 and defines a length of a lever engaging on the kingpin 280 and supported on the axles 205. If, for example, multiple axes 205 are equally loaded, the effective wheelbase leff is defined relative to the effective contact point. In the case of three equally loaded axles 205, for example, the effective contact point is arranged at a second, central axle 205; in the case of two equally loaded axles 205, the effective contact point is arranged precisely between the two axles 205.

The deceleration D of the vehicle 200a, 200b can be measured with the aid of an acceleration sensor and/or with the aid of wheel speed sensors. The further geometric data are obtained from the construction of the vehicle 200a, 200b and are vehicle-specific or vehicle-type-specific constants. From the above equation for the axle load transfer, it is clear that the influences due to the axle load transfer are low on account of the effective wheelbase leff of the semitrailer or trailer 200c, which is long in relation to the center of gravity height hM and the pin height hZ.

The vehicle 200a, 200b has the control device 250. The control device 250 is, for example, a central control device or a brake control device. The control device 250 is connectable or connected to the pressure sensor 170 (see FIG. 2 and 4) in order to capture the bellows pressure pB.

The control device 250 is configured to capture a braking requirement BA. The braking requirement BA may be defined, for example, by a driver of the tractor 200d and/or by an automated driving function. The braking requirement BA can include and/or define the brake pressure BP.

The control device 250 is configured to determine a setpoint braking variable BS based on the braking requirement BA and/or the brake pressure BP. In this case, the setpoint braking variable BS is determined via a segmented linear relationship 300 between the setpoint braking variable BS and the brake pressure BP (see FIG. 6). The control device 250 is configured to determine a braking variable difference BD (see FIG. 6) between the braking variable B and the setpoint braking variable BS and, on the basis thereof, to output a control signal 251 for adjusting, that is, for increasing and/or decreasing, the brake pressure BP.

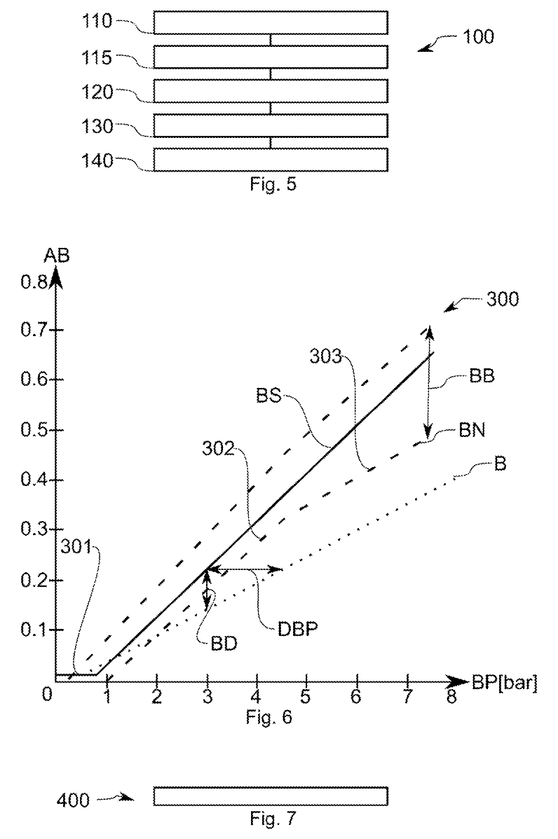

The vehicle 200a, 200b has a data processing device 255. The data processing device 255 is configured for wireless communication with a server external to the vehicle (not shown). The data processing device 255 is connected to the control device 250 in terms of communication. The control device 250 may be configured to ascertain 120 the braking variable B and/or to determine 130 a braking variable difference BD, to transmit the brake pressure BP, a braking request BA, the bellows pressure change pD and/or the bellows pressure pB to the data processing device 255 that is different from the control device 250. The data processing device 255 can determine the control signal 251 in accordance with the method 100 according to FIG. 5 and/or transmit the data received from the control device 250 to the server external to the vehicle, which determines the braking variable B and/or the setpoint braking variable BS. The data processing device 255 is a telematics device, for example.

FIG. 4 shows a schematic illustration of a trailer 200c as a vehicle 200a, in particular a commercial vehicle 200b, according to one aspect of the disclosure. The vehicle 200a, 200b shown in FIG. 4 is the vehicle 200a, 200b described with reference to FIG. 3. FIG. 4 is described with reference to FIGS. 1-3.

Here, the vehicle 200a, 200b has the axles 205 with the wheels 206 (not indicated in FIG. 4). As a component part of the braking system 290, a brake cylinder 295 is assigned to each of the wheels 206. The brake cylinder 295 of each wheel 206 can be supplied with the brake pressure BP in order to brake the wheel 206 or to exert a braking torque on the wheel 206. As a component part of the suspension system 260, a bellows 265 is assigned to each of the wheels 206. The bellows pressure pB prevails in the bellows 265 of each wheel 206.

The brake pressure BP and the bellows pressure pB can be measured by the pressure sensor 270. The pressure sensor 270 is a central pressure sensor 270 for measuring the brake pressures BP in a plurality of brake cylinders 295 and for measuring the bellows pressures pB in a plurality of bellows 265. In another embodiment, the vehicle 200a, 200b can have a plurality of pressure sensors 270 for measuring the pressure in one or more respective brake cylinders 295 and/or bellows 265.

The vehicle 200a, 200b has two compressed air lines 299 for carrying an air pressure from a tractor 200d (see FIG. 1) to the trailer 200c. For storing and/or setting pressures, the vehicle 200a, 200b has two compressed air accumulators 296 and a plurality of valves 297.

The vehicle 200a, 200b has a communication link 298. The communication link 298 is configured for data transfer between the tractor 200d and the trailer 200c. For example, the communication link 298 can be configured in accordance with ISO 7638-1:2018-05 "Road vehicles - Connectors for the electrical connection of tractors and trailer vehicles - Part 2: Plug-in device for brake systems and braking equipment of vehicles with a nominal voltage of 24 V" from May 2018.

FIG. 5 shows a schematic illustration of flow chart of a method 100 according to one aspect of the disclosure. The method 100 according to FIG. 5 is a method 100 for operating an electropneumatic brake system 290 for a vehicle 200a, 200b. A vehicle 200a, 200b of this kind is described with reference to FIGS. 1-4. FIG. 5 is described with reference to FIGS. 1-4.

The method 100 according to FIG. 5 includes: capturing 110 the bellows pressure pB during braking initiated by a braking request BA and achieved with a brake pressure BP. The method 100 includes: capturing 115 an axle load FA.

The method 100 includes: ascertaining 120 a braking variable B on the basis of the bellows pressure pB and/or a bellows pressure change pD that can be derived from the bellows pressure pB. The braking variable B is a braking ratio AB determined taking into account the axle load FA.

The method 100 includes: determining 130 a braking variable difference BD between the braking variable B and a setpoint braking variable BS, which can be determined on the basis of the braking request BA and/or the brake pressure BP. The setpoint braking variable BS is determined via a segmented linear relationship 300 between the setpoint braking variable BS and the brake pressure BP.

The method 100 includes: outputting 140 a control signal 251 for adjusting the brake pressure BP in dependence on the braking variable difference BD. The control signal 251 is outputted such that the brake pressure BP is increased or decreased in dependence on the braking variable difference BD. The control signal 251 is outputted such that the brake pressure BP is increased if the braking variable B is smaller than the setpoint braking variable BS. Alternatively, the control signal 251 is outputted such that the brake pressure BP is reduced if the braking variable B is greater than the setpoint braking variable BS. The control signal 251 is outputted such that the brake pressure BP is adjusted if the braking variable difference BD exceeds a threshold value. The brake pressure BP is increased such that at least the setpoint braking variable BS is established at the brake pressure BP. The brake pressure BP is adjusted such that a standardized standard braking variable BN and/or a braking variable B within a predetermined braking variable range BB is established at the brake pressure BP.

FIG. 6 shows a segmented linear relationship 300 for carrying out a method 100 according to one aspect of the disclosure. A segmented linear relationship 300 of this kind can be used to determine a setpoint braking variable BS on the basis of a braking request BA and/or a brake pressure BP. FIG. 6 is described with reference to FIGS. 1-5.

The segmented linear relationship 300 according to FIG. 6 shows a functional relationship between the braking ratio AB as the braking variable B and the brake pressure BP.

As shown by the dotted line, a braking variable B can be set in response to a brake pressure BP during braking. The braking variable B can be ascertained as described with reference to FIGS. 1-5.

In FIG. 6, a segmented linear relationship 300 with a continuous line shows a setpoint braking variable BS in dependence on the brake pressure BP. The segmented linear relationship 300 between the setpoint braking variable BS and the brake pressure BP can be stored, for example, in the control device 250 in order to determine the setpoint braking variable BS on the basis of the segmented linear relationship 300 between the setpoint braking variable BS and the brake pressure BP. At a certain brake pressure BP, the setpoint braking variable BS is substantially greater than the braking variable B. For a certain brake pressure BP, a braking variable difference BD between the braking variable B and the setpoint braking variable BS determined on the basis of the braking request BA and/or the brake pressure BP can thus be ascertained.

In order to allow the setpoint braking variable BS to be established and/or outputted, the outputting 140 of the control signal 251 for adjusting, or according to the example shown for increasing, the brake pressure BP in dependence on the braking variable difference BD is carried out. In this case, the brake pressure BP is increased by a brake pressure difference DBP in order to achieve the setpoint braking variable BS with a given performance of the brake system 290. The brake pressure BP is increased by the brake pressure difference DBP such that at least the setpoint braking variable BS is established at the brake pressure BP. In this case, the brake pressure BP is increased such that a standardized standard braking variable BN is exceeded and a braking variable B within a predetermined braking variable range BB is established at the brake pressure BP. This is applicable for fully unloaded vehicles 200a, 200b, since a maximum reference pressure must not exceed 7 bar, but a pressure level of 8.5 bar is present in the trailer 200c. This means that there is still a reserve of about 20%. In addition and alternatively, the braking operations are typically only slight partial braking operations in the pressure range around 1 bar. Such braking operations can very easily be corrected using the method 100.

The segmented linear relationship 300 has a first segment 301, a second segment 302 and a third segment 303. In the first segment 301 at a low brake pressure BP, no and/or a low and constant braking variable B is required, since a response pressure as the threshold value must first be exceeded. In the second segment 302, the braking variable B, for example the standard braking variable BN, rises with the brake pressure BP according to a first gradient, and in the third segment 303, the braking variable B, for example the standard braking variable BN, rises with the brake pressure BP according to a second gradient, which is different from the first gradient.

The segmented linear relationship 300 according to FIG. 6 is only exemplary. Additional linear segments can be added, for example in the case of a tiller trailer.

FIG. 7 shows a schematic illustration of a computer-readable medium 400 according to one aspect of the disclosure. The computer-readable medium 400 includes commands (not shown) which, when the program or the commands is or are executed by a control device 250, cause the latter to carry out the method 100 and/or the steps of the method 100 according to FIG. 5.

The commands may be present as a program code in any code or language, in particular in a code that is suitable for motor vehicle controllers. The computer-readable medium 400 may be or include any digital data storage device, such as a USB stick, a hard disk, a CD-ROM, an SD card, or an SSD card. The computer program does not necessarily have to be stored on such a computer-readable storage medium, but may also be retrievable via the Internet or in some other way.

It is understood that the foregoing description is that of the preferred embodiments of the invention and that various changes and modifications may be made thereto without departing from the spirit and scope of the invention as defined in the appended claims.

### Reference signs (part of the description)

100 method

110 capturing a bellows pressure

115 capturing an axle load

120 ascertaining

130 determining

140 outputting

200a vehicle

200b utility vehicle

200c trailer, trailer vehicle

200d tractor

201 multi-unit vehicle

202 center of gravity

205 axle

206 wheel

207 axle tube

210 vehicle frame

220 suspension link

230 mounting

250 control unit

251 control signal

255 data processing device

260 pneumatic suspension system

265 bellows

270 pressure sensor

280 kingpin

290 brake system

295 brake cylinder

296 compressed air accumulator

297 valve

298 communication link

299 compressed air line

300 segmented linear relationship

301 first segment

302 second segment

303 third segment

400 computer-readable medium

AB braking ratio

Aeff area of action

B braking variable

BA braking request

BB braking variable range

BD braking variable difference

BN standard braking variable

BP brake pressure

BS setpoint braking variable

D vehicle deceleration

DBP brake pressure difference

FA axle load

FB braking force

FBA

force on bellows, axle load transfer

FBB force on bellows due to braking

FBS static force on bellows

FBZ pin braking force

h height of a mounting

hM center of gravity height

hZ pin height

leff effective wheelbase

l0 length of a suspension link

l1 distance between mounting and axle

n number of axles

pB bellows pressure

pD bellows pressure change

pRef reference pressure

S axle load transfer

1. A method for operating an electropneumatic brake system for a vehicle, wherein the vehicle has a pneumatic suspension system having a bellows and has a pressure sensor for capturing a bellows pressure of the bellows, the method comprising:
capturing the bellows pressure during a braking operation initiated by a braking request and achieved with a brake pressure;
ascertaining a braking variable on a basis of at least one of the bellows pressure and a bellows pressure change that can be derived from the bellows pressure;
determining a braking variable difference between the braking variable and a setpoint braking variable that can be determined on a basis of at least one of the braking request and the brake pressure; and,
outputting a control signal for adjusting the brake pressure in dependence on the braking variable difference.

2. The method of claim 1, wherein the control signal is outputted such that the brake pressure is increased or decreased in dependence on the braking variable difference.

3. The method of claim 1, wherein the control signal is outputted such that the brake pressure is increased if the braking variable is smaller than the setpoint braking variable.

4. The method of claim 1, wherein the control signal is outputted such that the brake pressure is adjusted if the braking variable difference exceeds a threshold value.

5. The method of claim 1, wherein the brake pressure is increased such that at least the setpoint braking variable is established at the brake pressure.

6. The method of claim 1, wherein the brake pressure is adjusted such that at least one of a standardized standard braking variable and a braking variable within a predetermined braking variable range is established at the brake pressure.

7. The method of claim 1 further comprising:
capturing an axle load; and,
wherein the braking variable is a braking ratio determined taking into account the axle load.

8. The method of claim 1, wherein the setpoint braking variable is determined on a basis of a segmented linear relationship between the setpoint braking variable and the brake pressure.

9. The method of claim 1, wherein the vehicle is a commercial vehicle.

10. A computer program comprising program code configured, when executed by a control device, to cause the control device to carry out the method of claim 1.

11. A non-transitory computer readable medium comprising instructions stored on the non-transitory computer readable medium, wherein said instructions are configured, when executed by a control device, to carry out the method of claim 1.

12. A control device for a vehicle, wherein the vehicle has a pneumatic suspension system having a bellows and has a pressure sensor for capturing a bellows pressure of the bellows, , the control device comprising:
a processor;
a non-transitory computer readable medium having program code stored thereon;
said program code being configured, when executed by said processor, to
capture the bellows pressure during a braking operation initiated by a braking request and achieved with a brake pressure;
ascertain a braking variable on a basis of at least one of the bellows pressure and a bellows pressure change that can be derived from the bellows pressure;
determine a braking variable difference between the braking variable and a setpoint braking variable that can be determined on a basis of at least one of the braking request and the brake pressure; and,
output a control signal for adjusting the brake pressure in dependence on the braking variable difference.

13. The control device of claim 12, wherein, in order to determine the braking variable, the control device is configured for transmitting at least one of the bellows pressure change and the bellows pressure to a data processing device, different from the control device, on the vehicle.

14. The control device of claim 12, wherein the vehicle is a commercial vehicle.

15. A vehicle comprising:
a pneumatic suspension system having a bellows;
an electropneumatic brake system having a brake cylinder;
a pressure sensor device for capturing a bellows pressure of said bellows and a brake pressure of the brake cylinder; and,
a control device connected to said pressure sensor device;
said control device being configured to:
capture the bellows pressure during a braking operation initiated by a braking request and achieved with a brake pressure;
ascertain a braking variable on a basis of at least one of the bellows pressure and a bellows pressure change that can be derived from the bellows pressure;
determine a braking variable difference between the braking variable and a setpoint braking variable that can be determined on a basis of at least one of the braking request and the brake pressure; and,
output a control signal for adjusting the brake pressure in dependence on the braking variable difference.

16. The vehicle of claim 15, wherein the vehicle is or has a trailer vehicle of a multi-unit vehicle.

17. The vehicle of claim 15, wherein the vehicle is a commercial vehicle.
